(19) United States
(12) Patent Application Publication
(10) Pub. No.: US 2019/0214013 A1
(43) Pub. Date: Jul. 11, 2019

(54) SPEECH-TO-TEXT CONVERSION BASED ON USER INTERFACE STATE AWARENESS

(71) Applicant: CA, Inc., New York, NY (US)

(72) Inventors: Sunil Meher, Hyderabad (IN); Bidyapati Pradhan, Hyderabad (IN); Bharath Kumar Kristam, Hyderabad (IN); Prashanth Patha, Karimnagar (IN)

(73) Assignee: CA, Inc., New York, NY (US)

(21) Appl. No.: 15/863,121

(22) Filed: Jan. 5, 2018

(51) Int. Cl. G10L 15/26; G10L 15/30; G06F 3/16; G06F 17/24

(52) U.S. Cl. CPC G10L 15/265; G06F 17/243; G06F 3/167; G10L 15/30

(57) ABSTRACT

A web server system identifies a webpage being accessed by a user through a client terminal. The webpage is among a set of possible webpages that are accessible through the client terminal. Different identifiers are assigned to different ones of the webpages. Responsive to the identifier of the webpage, a set of user interface (UI) input field constraints is selected that define what the webpage allows to be input by a user to a set of UI fields provided by the webpage. An output text string is obtained that is converted from a sampled audio steam by a speech-to-text conversion server and that is constrained to satisfy one of the UI field input constraints of the selected set. The output text string is provided to an application programming interface of the webpage that corresponds to one of the UI fields having user input constrained by the UI field input constraint of the selected set.

### TECHNICAL FIELD

The present disclosure is related to computer systems that perform speech-to-text conversion processing.

### BACKGROUND

Speech-to-text conversion is presently used for many computer applications, including to allow users to vocally navigate call center menus and other computer interfaces. Some speech conversion products hosted on user devices convert spoken words into commands that control the functionality of the user device. However, these products require a user to speak the exact word commands which are needed to perform a particular function, because the speech-to-text conversion merely match the spoken word to a closest word within a library. Speaking the wrong word command or not knowing what command to use results in failed operation.

### SUMMARY

Some embodiments disclosed herein are directed to methods by a web server system. An identifier of a webpage being accessed by a user through a client terminal is identified. The webpage is among a set of possible webpages that are accessible to the user through the client terminal. Different identifiers are assigned to different ones of the webpages. Responsive to the identifier of the webpage, a set of user interface (UI) input field constraints is selected that define what the webpage allows to be input by a user to a set of UI fields which are provided by the webpage. An output text string is obtained that is converted from a sampled audio steam by a speech-to-text conversion server and that is constrained to satisfy one of the UI field input constraints of the selected set. The output text string is provided to an application programming interface of the webpage that corresponds to one of the UI fields having user input constrained by the one of the UI field input constraints of the selected set.

Some other related embodiments disclosed herein are directed to methods by a natural language speech processing computer. An identifier of a presently active UI operational state of an application executed by a computer terminal is determined. The presently active UI operational state is among a set of possible UI operational states of the application. Different identifiers are assigned to different ones of the possible UI operational states. Responsive to the identifier of the presently active UI operational state, a set of UI field input constraints is selected that define what the application allows to be input by a user to a set of UI fields which are provided by the presently active UI operational state of the application. An output text string is obtained that is converted from a sampled audio steam by a speech-to-text conversion server and that is constrained to satisfy one of the UI field input constraints of the selected set. The output text string is provided to an application programming interface of the application that corresponds to one of the UI fields having user input constrained by the one of the UI field input constraints of the selected set.

Some other related embodiments disclosed herein are directed to a web server system that includes a network interface, a processor, and a memory. The network interface is configured to communicate with a speech-to-text conversion server. The processor is connected to receive the data packets from the network interface. The memory stores program instructions executable by the processor to perform operations. The operations include determining an identifier of a webpage being accessed by a user through a client terminal. The webpage is among a set of possible webpages that are accessible to the user through the client terminal. Different identifiers are assigned to different ones of the webpages. Responsive to the identifier of the webpage, a set of UI input field constraints is selected that define what the webpage allows to be input by a user to a set of UI fields which are provided by the webpage. An output text string is obtained that is converted from a sampled audio steam by a speech-to-text conversion server and that is constrained to satisfy one of the UI field input constraints of the selected set. The output text string is provided to an application programming interface of the webpage that corresponds to one of the UI fields having user input constrained by the one of the UI field input constraints of the selected set.

It is noted that aspects described with respect to one embodiment disclosed herein may be incorporated in different embodiments although not specifically described relative thereto. That is, all embodiments and/or features of any embodiments can be combined in any way and/or combination. Moreover, methods, web server systems, natural language speech processing computers, and/or computer program products according to embodiments will be or become apparent to one with skill in the art upon review of the following drawings and detailed description. It is intended that all such additional methods, web server systems, natural language speech processing computers, and/or computer program products be included within this description and protected by the accompanying claims.

### BRIEF DESCRIPTION OF THE DRAWINGS

Aspects of the present disclosure are illustrated by way of example and are not limited by the accompanying drawings. In the drawings:

FIG. 1 is a block diagram of a computer system that includes a user interface (UI) state aware natural language (NL) processing computer that operationally interfaces with a web server, a NL speech-to-text server, and a client terminal in accordance with some embodiments;

FIG. 2 illustrates a plurality of UI operational states of webpages and further illustrates a set of UI input fields of one UI operational state of a webpage that a user can target for providing voice input in accordance with some embodiments;

FIG. 3 is a combined data flow diagram and flowchart of operations that may be performed by the client terminal, the UI state aware NL speech-to-text server, and the NL speech-to-text server of FIG. 1 in accordance with some embodiments;

FIGS. 4-7 are flowcharts of some operations that can be performed by the UI state aware NL speech-to-text server of FIG. 1 in accordance with some other embodiments;

FIG. 8 is a combined data flow diagram and flowchart of operations that may be performed a helpdesk application server that performs natural language speech processing based on UI state awareness in accordance with some embodiments;

FIG. 9 is a block diagram of a NL interface system that is configured in accordance with some embodiments; and

FIG. 10 is a block diagram of a client terminal that is configured in accordance with some embodiments.

### DETAILED DESCRIPTION

Various embodiments will be described more fully hereinafter with reference to the accompanying drawings. Other embodiments may take many different forms and should not be construed as limited to the embodiments set forth herein. Like numbers refer to like elements throughout.

According to various embodiments of the present disclosure, a natural language (NL) speech processing computer system is provided for enabling users to provide spoken commands and other information while navigating webpages and other computer based user interfaces (UIs). The NL speech processing computer system converts a user's sampled voice to a text string through speech-to-text conversion processing, and processes the converted text string using an awareness of a present UI state to generate an output text string that satisfies an operational constraint on providing input to the webpage or other computer based UI. Various embodiments can provide substantial improvement to the accuracy with which a spoken word or phrase is converted to text that can be used to control one or more targeted UI input fields of the webpage or other computer based UI. The word or phrase spoken by a user may not match any command or other information that is allowed to be input to a targeted UI input field. However, through various operations herein, the spoken word or phrase is converted to be among a set of defined commands or other defined information that is allowed to be input to a targeted UI input field of a webpage. This conversion is possible because the NL speech processing computers are aware of a set of UI field input constraints for one or more UI fields provided by a present webpage, and constrain the output text string to satisfy a UI field input constraint. The output text string is not necessarily a direct conversion of the spoken word or phrase through phonetic matching, but further includes more logical conversion of the spoken word or phrase to an output text string that is appropriate as input to a particular UI field of the webpage or other computer based UI.

These NL speech processing computers may be particularly beneficial for web-based product helpdesks and similar UI environments where users typically are not familiar with how to effectively describe the problem for which they seek assistance and are not familiar with what functional commands are available in the helpdesk for their use.

In one illustrative embodiment, speech that is converted into text through speech-to-text conversion processing, can be processed using an identifier of a present UI state of a webpage to generate an output text string that is constrained to be among a set of text strings that have been defined to satisfy a UI field input constraint of a UI field of the webpage that the user is targeting for providing voice input.

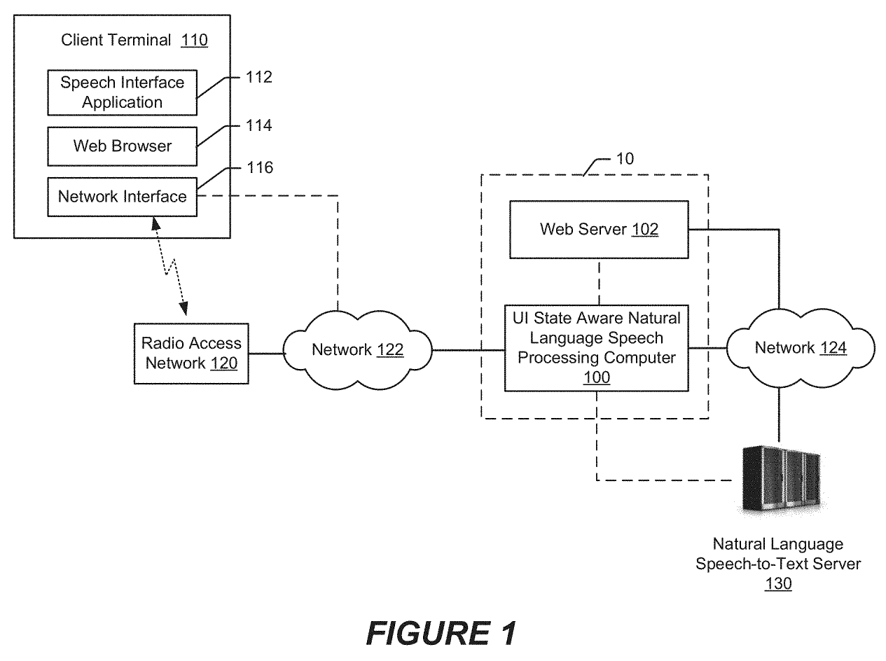

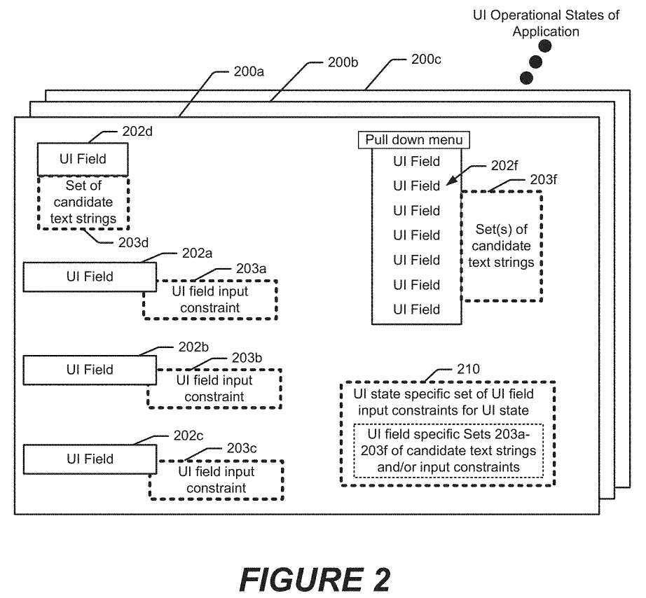

FIG. 1 is a block diagram of a computer system that includes a UI state aware NL processing computer 100 that operationally interfaces with a web server 102, a NL speech-to-text server 130, and a client terminal 110 in accordance with some embodiments. FIG. 2 illustrates a plurality of UI operational states 200a-200c of webpages that can be displayed on the display device of the client terminal 110 and further illustrates a set of UI input fields 202 of one UI operational state of a webpage 200a that a user can target for providing voice input through a microphone connected to the client terminal 110 in accordance with some embodiments.

Referring to FIGS. 1 and 2, a user operates the client terminal 110 to attempt to provide voice input to one of the UI fields 202 of the webpage 200a. The client terminal 110 includes at least one processor that executes a speech interface application 112 and a web browser 114, and that communicates through a network interface 116 with the UI state aware NL processing computer 100, referred to as “UI state NL computer 100” for brevity.

The network interface 116 may communicate with the UI state NL computer 100 through a wired connection (e.g., Ethernet) to a data network 122 (e.g., public and/or private network) and/or through a radio interface (e.g., 3GPP cellular interface, WLAN, etc.) with a radio access network (e.g., radio transceiver base station, enhanced NodeB, remote radio head, WLAN access point) with the network 122.

The UI state NL computer 100 can be connected to the web server 102 through a direct connection and/or through a data network 124, which may be part of the data network 122. Similarly, the UI state NL computer 100 can be connected to the NL speech-to-text server 130 through a direct connection and/or through the data network 124. Although illustrated and described as separate elements for non-limiting ease of explanation, some or all operations disclosed herein as being performed by any one the UI state NL computer 100, the web server 102, or the NL speech-to-text server 130 can be at least partially or entirely performed by any other one or any combination of other ones of the UI state NL computer 100, the web server 102, and the NL speech-to-text server 130.

A webpage having embedded UI fields for receiving user input (also referred to as “UI input fields”), can be provided by the Web server 102 for display through the web browser 114 on the client terminal 110. The presently displayed webpage is an example UI operational state. When the webpage is modified to provide one or more different UI fields and/or when another webpage is loaded responsive to, e.g., another URL being provided through the web browser 114, another UI operational state is thereby provided. Other application program user interfaces are other types of UI operational states. FIG. 2 illustrates a plurality of UI operational states, i.e., a sequence of webpages 200a, 200b, 200c that can be sequentially displayed responsive to user selections and/or user provided URLs. FIG. 2 further illustrates a set of UI fields 202 of webpage 200a. In the example of FIG. 2, the webpage 200a provides four discrete UI fields 200a-200d in which a user can provide input, and further provides a pulldown menu having seven UI fields collectively referred to as 202f in any one of which a user can provide input. The other UI operational states, e.g., other web pages 200b, 200c, etc., can have different numbers and types of UI fields.

In accordance with some embodiments, the webpage 200a has a set 210 of UI field input constraints that define what the webpage 200a allows a user to input the set of UI fields 200a-200f which are provided by the webpage 200a. Similarly, the other webpages, e.g., 200b, 200c, etc., each have a respective set 210 of UI field input constraints that define what the webpage 200a allows to be input by a user to the set of UI fields 200a-200f which are provided by the respective one of the other webpages.

At least some and perhaps all of the UI fields of a webpage can have different UI field input constraints that define what a user can enter into the particular ones of the UI fields. Example UI field input constraints that can be defined by the set 210 can include: UI field 202a operationally accepts only an account number (e.g., UI field input constraint 203a); UI field 202b only operationally accepts a password which must comply with password requirement constraints requiring that it not match any word contained in a defined electronically accessible dictionary (e.g., UI field input constraint 203b); UI field 202c only operationally accepts a text string having a character length within a defined range (e.g., UI field input constraint 203c); UI field 202d only operationally accepts a user inputting a text string that matches, for example, a descriptive name of one of a plurality of displayed user selectable buttons (e.g., set of candidate text strings forming UI field input constraint 203d); and UI fields 202f only operationally accept a user inputting a defined candidate text string that matches, for example, a descriptive name of one of the user selectable descriptive elements of the pull down menu (e.g., one or more other sets of candidate text strings forming UI field input constraint 203f).

A text string may include only numbers, only alphabetic characters, only special characters (e.g., @, !, #, $, %, etc.) or any combination of numbers, alphabetic characters, and/or special characters.

Thus, the set 210 can define constraints on characteristics of what a user can vocally provide as input to various defined UI fields and/or can define a set of candidate text strings which must be matched by what the user vocalizes as input target as input to certain ones of the defined UI fields. When the set 210 defines a set of candidate text strings (e.g., user selectable descriptive elements of a menu), the text string that is output by these operations of the UI state NL computer 100 must match one of the candidate text strings among the set to be an operationally valid input to the defined UI field.

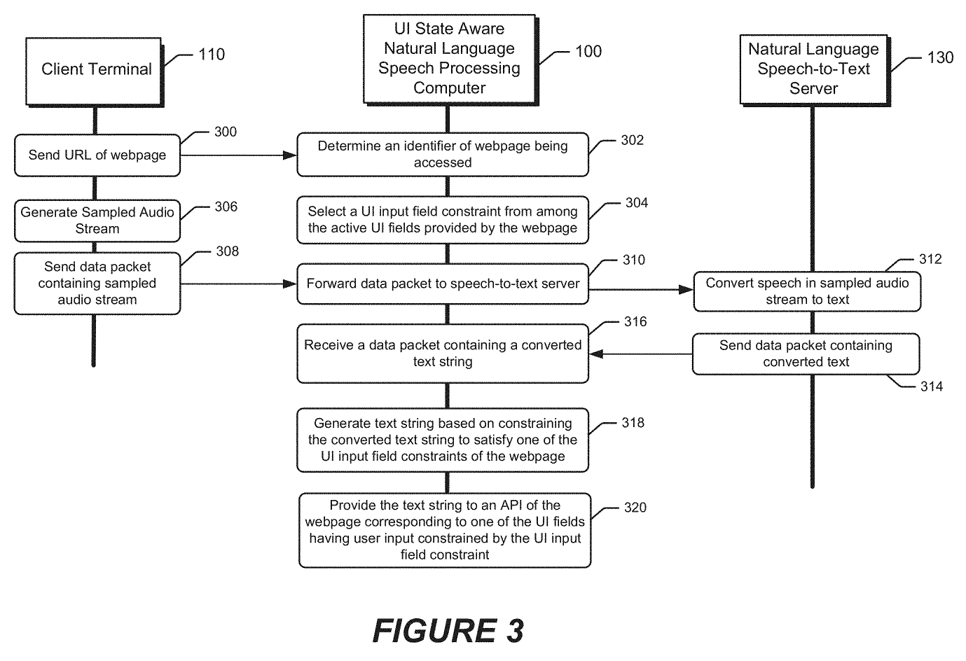

FIG. 3 is a combined data flow diagram and flowchart of operations that may be performed by the client terminal 110, the UI state NL computer 100, and the NL speech-to-text server 130 of FIG. 1 in accordance with some embodiments.

Referring to FIG. 3, the client terminal 110 sends 300 a URL for a webpage to the UI state NL computer 100. The UI state NL computer 100 determines 302 an identifier of the webpage being accessed by the user. The webpage is among a set of possible webpages that are accessible to the user through the client terminal 110, and different identifiers are assigned to different ones of the webpages. Responsive to the identifier of the webpage, the UI state NL computer 100 selects 304 a set of UI input field constraints that define what the webpage allows to be input by a user to a set of UI fields which are provided by the webpage.

The UI state NL computer 100 obtains a text string that is converted from a sampled audio steam by a speech-to-text conversion server and that is constrained to satisfy one of the UI field input constraints of the selected set. In the illustrated embodiment of FIG. 3, the client terminal 110 generates 306 a sampled audio stream, which may be generated by the speech interface application 112 sampling a user's speech in a microphone signal. The client terminal 110 sends 308 the data packet containing the sampled audio stream to the UI state NL computer 100. The UI state NL computer 100 forwards 310 the data packet to the natural language speech-to-text server 130, such as by embedding the received sampled audio stream in the output data packet, and communicating the data packet toward the natural language speech-to-text server 130 via the data network 124. The natural language speech-to-text server 130 converts 312 speech in the sample audio stream to text, and sends 314 the converted text string in a data packet to the UI state NL computer 100.

The UI state NL computer 100 receives 316 the data packet containing the converted text string, and generates 318 an output text string based on constraining the converted text string to satisfy one of the UI field input constraints among the selected set of UI input field constraints of the identified webpage. The UI state NL computer 100 provides 320 the output text string to an application programming interface (API) of the webpage that corresponds to one of the UI fields that has a constraint on operationally allowed user input by the one of the UI field input constraints of the selected set of UI input field constraints.

In some embodiments, the output text string is generated 318 based on comparison of the converted text string to a defined set of candidate text strings, so that the text string which is output matches one of the candidate text strings among the defined set even when the user vocalized a word or phrase that does not directly match one of the candidate text strings, e.g., when the user does not speak the precise word or phrase of any one of the candidate text strings.

In some other embodiments, the output text string is generated 318 based on comparison of the converted text string to a defined set of UI field input constraints, and a particular one of the UI fields is selected by the UI state UL computer 100 to receive the converted text string based on the converted text string being determined to satisfy the UI field input constraint associated with the particular one of the UI fields. Accordingly, a user can vocalize a command or information while viewing a webpage having a plurality of UI input fields, and the computer 100 can automatically identify one of the UI input fields to which the converted text is output, e.g., via an API of the UI input field, based on which one of the corresponding UI field input constraints is determined to be satisfied by the converted text.

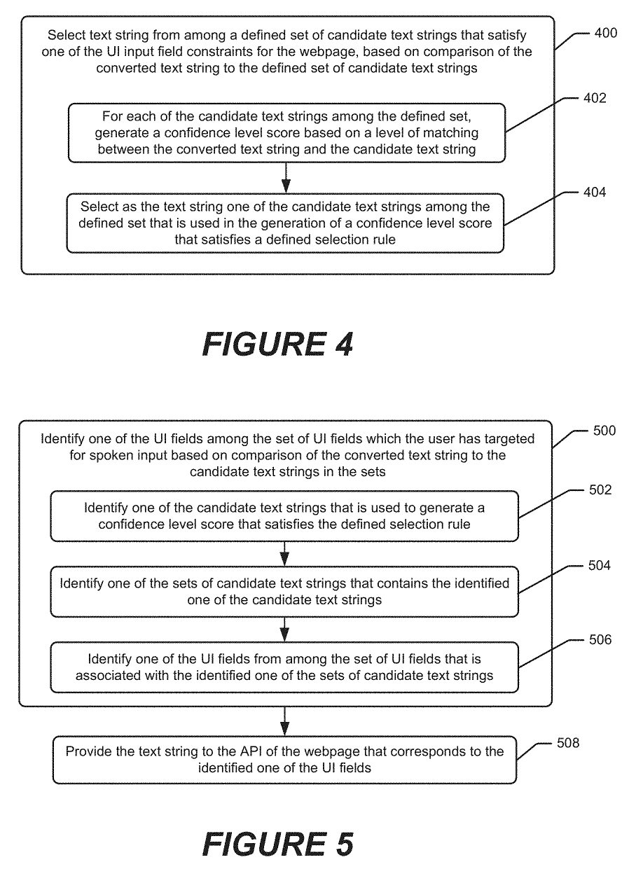

Referring to the flowchart of operations by the UI state NL computer 100 shown in FIG. 4, the UI state NL computer 100 may generate the output text string based on selecting 400 the text string from among a defined set of candidate text strings that satisfy the one of the UI field input constraints of the selected set, based on comparison of the converted text string to the defined set of candidate text strings. The UI state NL computer 100 may identify a closest match between the converted text string and one of the candidate text strings among the defined set, and output the closest matching one of the candidate text strings as the output text string.

With continued reference to FIG. 4, the operation for selecting 400 the text string from among the defined set of candidate text strings can include, repeating for each of the candidate text strings among the defined set, generating 402 a confidence level score based on a level of matching between the converted text string and the candidate text string. The output text string is then selected 404 as one of the candidate text strings among the defined set, which is used in the generation of a confidence level score, that satisfies a defined selection rule. The output text string may be selecting as one of the candidate text strings among the defined set that is used in the generation of a greater confidence level score than the other candidate text strings among the defined set.

In some related embodiments, the accuracy with which the spoken word or phrase is provided to one of the UI input fields, is improved by identifying which of the UI fields the user is targeting for the spoken input. Referring to the flowchart of operations by the UI state NL computer 100 shown in FIG. 5, a sub-set of the UI fields among the set provided by the webpage are each associated with a respective set of candidate text strings that satisfy UI field input constraints of the respective UI field. The UI state NL computer 100 identifies 500 one of the UI fields among the set of UI fields which the user has targeted for spoken input based on comparison of the converted text string to the candidate text strings in the sets. The output text string is provided to the application programming interface of the webpage that corresponds to the identified one of the UI fields.

In some additional or alternative embodiments, the UI state NL computer 100 identifies 500 one of the UI fields among the set of UI fields which the user has targeted for spoken input based on comparison of the converted text string to a set of UI field input constraints corresponding to the UI fields, and selecting one of the UI fields that is to receive the converted text string based on the converted text string satisfying the UI field input constraints for that UI field.

With continued reference to FIG. 5, one of the UI fields is identified 500 among the sub-set of UI fields that the user has targeted for spoken input, based on identifying 502 one of the candidate text strings that is used to generate a confidence level score that satisfies the defined selection rule, and then identifying 504 one of the sets of candidate text strings that contains the identified one of the candidate text strings. One of the UI fields is identified 506 from among the sub-set of UI fields that is associated with the identified one of the sets of candidate text strings.

Some further embodiments are directed to operations for selecting an output text string based on comparisons of the converted text string to the candidate text strings. In some embodiments, different UI input fields have different defined confidence threshold values must be satisfied for one of the candidate text strings to be selected as the output text string. For example, a UI input field that would trigger deletion of important client information can be assigned a higher confidence threshold value then another UI input field that triggers navigation to another menu interface but does not result in loss of client information.

Reference is now made to the flowchart of operations by the UI state NL computer 100 shown in FIG. 6. Confidence threshold values are assigned to the UI fields provided by the webpage, and at least some of the UI fields are assigned different confidence threshold values. The UI state NL computer 100 identifies 600 one of the UI fields among the set of UI fields that the user has targeted for spoken input, and selects 608 one of the confidence threshold values based on the identified one of the UI fields. The defined selection rule is satisfied when the confidence level score, which is generated using one of candidate text strings, satisfies the selected one of the confidence threshold values.

In some additional or alternative embodiments, the UI state NL computer 100 tracks historical sequences of selection of different webpage elements, and identifies one of the UI input fields that the user has targeted for spoken input based on observing a sequence of at least two previous UI fields that have been identified as what the user previously targeted for spoken input.

With continued reference to FIG. 6, the UI state NL computer 100 identifies 600 one of the UI fields that the user has targeted for spoken input, based on tracking 602 historical ordered sequences for which user input has been provided to the UI fields among the set of UI fields of the webpage over time. The UI state NL computer 100 identifies 604 a present sequence of at least two of the UI fields among the set of UI fields of the webpage that the user has immediately previously targeted for spoken inputs, and predicts 606 a next one of the UI fields among the set of UI fields of the webpage that the user will target for spoken input, based on comparison of the present sequence to the historical ordered sequences. The predicted next one of the UI fields is the identified one of the UI fields.

In an additional or alternative embodiment, when the UI state NL computer 100 is operating to automatically select a particular one of the UI fields to receive the converted text string based on the converted text string being determined to satisfy the UI field input constraint associated with the particular one of the UI fields, the UI state UL computer 100 can select a particular UI field from among a sub-set of the UI fields that are all determined to have corresponding UI field input constraints that are satisfied by the converted text string, based on the particular UI field being further determined to be a most likely UI field among that the user is presently targeting for the vocalized speech based on which one or more other UI fields were immediately previously determined to have been targeted for user input and in view of the tracked 602 historical ordered sequences for which user input has been provided to the UI fields among the set of UI fields of the webpage over time.

Some additional or alternative further embodiments are directed to operations for controlling whether an output text string is provided as input to one of the UI input fields based on use of the different confidence threshold values assigned to various ones of the UI input fields. Referring to the operations by the UI state NL computer 100 shown in FIG. 7, confidence threshold values are assigned to the UI fields that are provided by the webpage, and at least some of the UI fields are assigned different confidence threshold values. One of the UI fields is identified 700 among the set of UI fields that the user has targeted for spoken input, and one of the confidence threshold values is selected 702 based on the identified one of the UI fields. The confidence level score, which is generated using one of candidate text strings, is compared 704 to the selected one of the confidence threshold values.

Responsive to determining 704 that the confidence level score satisfies the selected one of the confidence threshold values, the text string is provided 706 to the API of the webpage that corresponds to the identified one of the UI fields; and

In contrast, responsive to determining 704 that the confidence level score does not satisfy the selected one of the confidence threshold values, the text string is prevented 708 from being provided to the API of the webpage that corresponds to the identified one of the UI fields.

Various embodiments of been described herein in the context of providing spoken input to UI input fields of a webpage, these and other embodiments herein are not limited thereto. Alternative or additional operations it can more generally be performed by a natural language speech processing computer are now explained.

A natural language speech processing computer can perform operations to determine an identifier of a presently active UI operational state of an application (e.g., a present UI state of a displayed UI arrangement) executed by a computer terminal. The presently active UI operational state is among a set of possible UI operational states of the application, and different identifiers are assigned to different ones of the possible UI operational states. Responsive to the identifier of the presently active UI operational state, a set of UI field input constraints are selected that define what the application allows to be input by a user to a set of UI fields which are provided by the presently active UI operational state of the application. An output text string is obtained that is converted from a sampled audio steam by a speech-to-text conversion server and that is constrained to satisfy one of the UI field input constraints of the selected set. The output text string is provided to an API of the application that corresponds to one of the UI fields having user input constrained by the one of the UI field input constraints of the selected set.

The operations may further include embedding the sampled audio stream in a data packet, and communicating the data packet toward a speech-to-text conversion server via a data network. Operations for obtaining the output text string include receiving, via the data network, a data packet containing a converted text string that is converted from the sampled audio steam by the speech-to-text conversion server, and selecting the output text string from among a defined set of candidate text strings that satisfy the one of the UI field input constraints of the selected set, based on comparison of the converted text string to the defined set of candidate text strings.

Operations to select the output text string from among the defined set of candidate text strings, can include for each of the candidate text strings among the defined set, generating a confidence level score based on a level of matching between the converted text string and the candidate text string. The output text string is then selected as one of the candidate text strings among the defined set that is used in the generation of a confidence level score that satisfies a defined selection rule. The output text string can be selected as one of the candidate text strings among the defined set that is used in the generation of a greater confidence level score than the other candidate text strings among the defined set.

In a further embodiment, a sub-set of the UI fields among the set provided by the presently active UI operational state of the application are each associated with a respective set of candidate text strings that satisfy UI field input constraints of the respective UI field. Operations can further include identifying one of the UI fields among the sub-set of UI fields that the user has targeted for spoken input based on comparison of the converted text string to the candidate text strings in the sets. The output text string is then provided to the application programming interface of the application that corresponds to the identified one of the UI fields.

The operations to identify one of the UI fields among the sub-set of UI fields that the user has targeted for spoken input, can include identifying one of the candidate text strings that is used to generate a confidence level score that satisfies the defined selection rule, and identifying one of the sets of candidate text strings that contains the identified one of the candidate text strings. One of the UI fields is identified from among the sub-set of UI fields that is associated with the identified one of the sets of candidate text strings.

Different UI input fields can be assigned different confidence threshold values that must be satisfied one of the candidate text strings to be selected as the output text string for input to the particular UI input field. Thus, confidence threshold values are assigned to the UI fields that are provided by the presently active UI operational state of the application, and at least some of the UI fields are assigned different confidence threshold values. The operations include identifying one of the UI fields among the set of UI fields that the user has targeted for spoken input, and selecting one of the confidence threshold values based on the identified one of the UI fields. The defined selection rule is determined to be satisfied when the confidence level score, which is generated using one of candidate text strings, satisfies the selected one of the confidence threshold values.

In some alternative or additional embodiments, the natural language speech processing computer operates to identify one of the UI fields among the set of UI fields that the user has targeted for spoken input, by further operations that include tracking historical ordered sequences for which user input has been provided to the UI fields among the set of UI fields over time, and identifying a present sequence of at least two of the UI fields among the set of UI fields that the user has immediately previously targeted for spoken inputs. The operations predict a next one of the UI fields among the set of UI fields that the user will target for spoken input, based on comparison of the present sequence to the historical ordered sequences, wherein the predicted next one of the UI fields is the identified one of the UI fields.

In some alternative or additional embodiments, confidence threshold values are assigned to the UI fields that are provided by the presently active UI operational state of the application, and at least some of the UI fields are assigned different confidence threshold values. The natural language speech processing computer operates to identify one of the UI fields among the set of UI fields that the user has targeted for spoken input, and select one of the confidence threshold values based on the identified one of the UI fields. The confidence level score, which is generated using one of candidate text strings, is compared to the selected one of the confidence threshold values. Responsive to the confidence level score being determined to satisfy the selected one of the confidence threshold values, the output text string is provided to the API of the application that corresponds to the identified one of the UI fields. In sharp contrast, responsive to the confidence level score being determined to not satisfy the selected one of the confidence threshold values, the output text string is prevented from being provided to the application programming interface of the application that corresponds to the identified one of the UI fields.

Some other embodiments are directed to a web server system that includes a network interface, a processor, and a memory. The network interface is configured to communicate with a speech-to-text conversion server. The processor is connected to receive the data packets from the network interface. The memory stores program instructions executable by the processor to perform operations. The operations include determining an identifier of a webpage being accessed by a user through a client terminal. The webpage is among a set of possible webpages that are accessible to the user through the client terminal, wherein different identifiers are assigned to different ones of the webpages. Responsive to the identifier of the webpage, the operations select a set of UI input field constraints that define what the webpage allows to be input by a user to a set of UI fields which are provided by the webpage. The operations obtain an output text string that is converted from a sampled audio steam by a speech-to-text conversion server and that is constrained to satisfy one of the UI field input constraints of the selected set, and provide the output text string to an API of the webpage that corresponds to one of the UI fields having user input constrained by the one of the UI field input constraints of the selected set.

In a further embodiment, the sampled audio stream is embedded in a data packet, and communicated toward a speech-to-text conversion server via a data network. Operations to obtain the output text string include receiving, via the data network, a data packet containing a converted text string that is converted from the sampled audio steam by the speech-to-text conversion server. For each of the candidate text strings among the defined set, operations generate a confidence level score based on a level of matching between the converted text string and the candidate text string. The operations then select as the output text string one of the candidate text strings among the defined set that is used in the generation of a confidence level score that satisfies a defined selection rule.

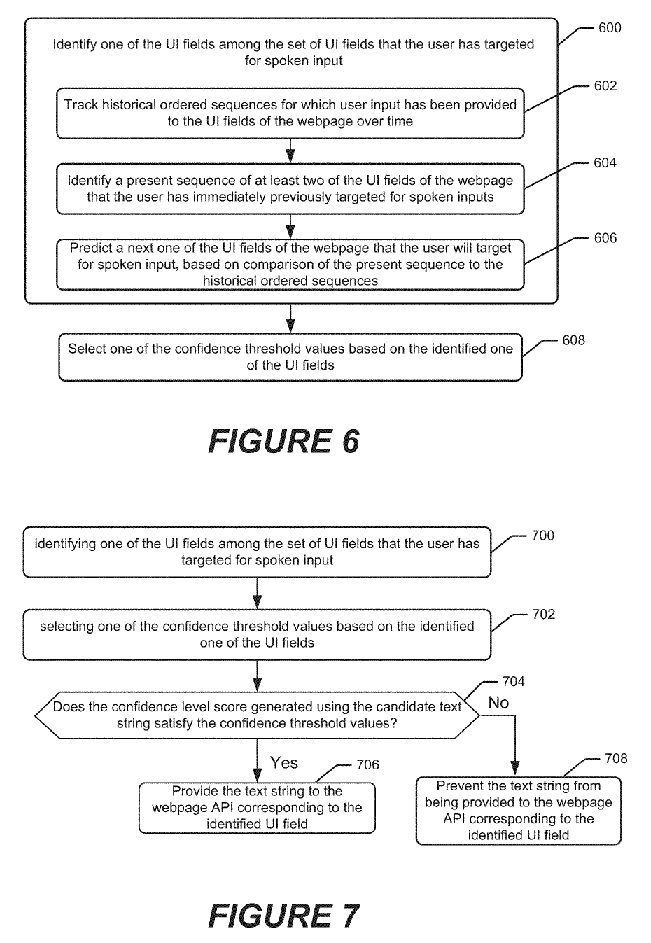

Various embodiments of been described above in the context of providing spoken input to UI input fields of a webpage. Other embodiments of the present disclosure are not limited thereto. Some of these other embodiments are directed to providing natural language speech processing for helpdesk applications. Virtual assistant functionality can be provided to assist users who using voice to interact with an automated helpdesk application during a phone call (e.g., via a Public Switched Telephone Network call or Voice Over IP call). FIG. 8 is a combined data flow diagram and flowchart of operations that may be performed a helpdesk application server 100a that performs natural language speech processing based on UI state awareness in accordance with some embodiments.

Referring to FIG. 8, example operations that can be performed by the helpdesk application server 100a include, without limitation, providing URL navigation for a single page web application using natural language processing to determine another URL to which the session is redirected. For example, the server 100a may process a user command of “Show all Priority 1 tickets in my queue” to responsively provide the user with a listing of all priority one tickets assigned to that particular user. Another example user command is “Open Ticket #25” which will trigger the server 100a to retrieve information characterizing that particular ticket and which is then provided to the user.

Another example operation by the server 100a is to assist a user by providing system authorized data for that user. For example, the server 100a can respond to the user command “What is status of ticket#45”, by communicating the status of that particular ticket through voice.

Another example operation by the server 100a is to assist a user to update authorized data. For example, the server 100a can respond to the user command “Transfer the ticket #32 to John Doe” which will update the ticket handling database to transfer the ticket to user John Doe.

Another example operation by the server 100a is to assist a user with filling-in information in a web application form. For example, the server 100a can respond to the user command “Create a ticket with summary as Laptop is not working”, by possibly asking the user one or more defined questions that seek further characteristics of the Laptop and/or the problem and then populate entries in a helpdesk form.

Referring to FIG. 8, a user operating a client phone 110a establishes 800 a voice call the helpdesk application server 100a. The helpdesk application server 100a determines 802 an identifier of an active UI operational state of the application (e.g., an initial state where user problem information is gathered for a new problem ticket), and selects 804 a set of UI input field constraints that define what the helpdesk application allows to be input by a user to a set of UI fields which are provided by the active UI operational state (e.g., user's name, user's address, defined list of computer characteristics, defined list of problem characteristics, etc.). The helpdesk application server 100a forward the speech in a data packet to the natural language speech-to-text server 130, where it is converted 808 to text that is returned 810 in a data packet containing the converted text.

The helpdesk application server 100a receives 812 the data packet and generates 814 a text string based on constraining the converted text string to satisfy one of the UI input field constraints of the webpage. The text string may be used to populate a helpdesk form with information provided by the user. Alternatively, the text string may be may be used to select among a list of URLs to which operations should be redirected, where the list of URLs may be for resources provided on the helpdesk application server 100a and/or which are provided by another server that is networked to the helpdesk application server 100a.

The helpdesk application server 100a may provide 818 a voice response to the user, where the voice response may be generated responsive to the text string.

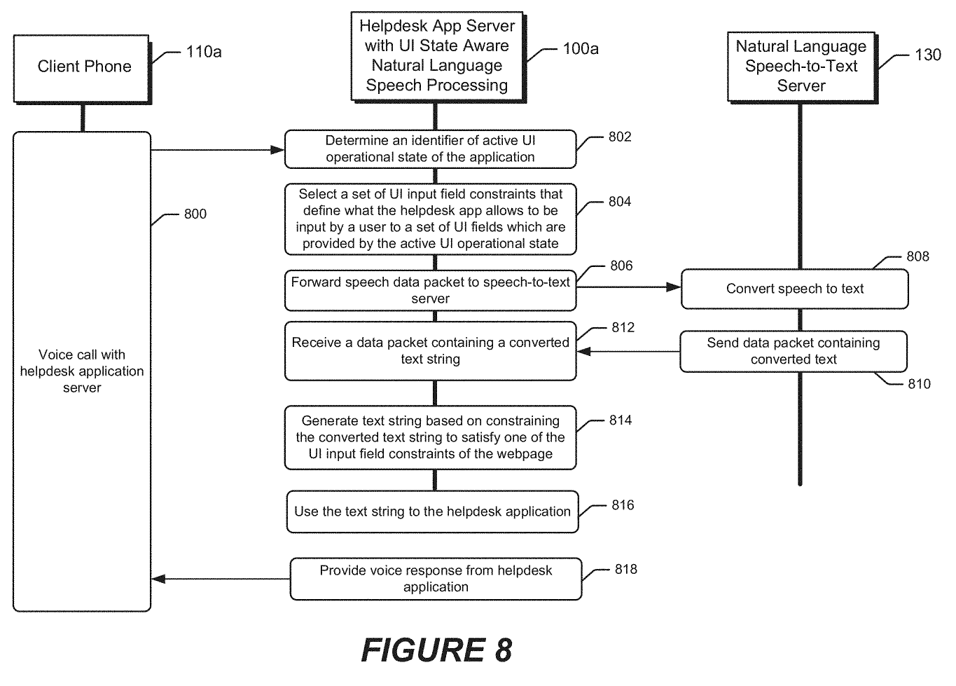

FIG. 9 is a block diagram of a NL interface system 10 that can be configured to perform operations in accordance with some embodiments. The system 10 can include the server 102, the UI state aware NL speech processing computer 100, and/or the NL speech-to-text server 130, and/or other system components configured to operate according one or more embodiments herein. Referring to FIG. 9, the system 10 can include network interface circuitry 930 (hereinafter “network interface”) which communicates via the one or more data networks 122 and/or 124 with the radio access network 120, the Web server 102, the natural language speech-to-text server 130, and/or other components of the system 10. The system 10 includes processor circuitry 910 (hereinafter “processor”) and memory circuitry 930 (hereinafter “memory”) that contains computer program code 922 which performs various operations disclosed herein when executed by the processor 910. The processor 910 may include one or more data processing circuits, such as a general purpose and/or special purpose processor (e.g., microprocessor and/or digital signal processor), which may be collocated or distributed across one or more data networks (e.g., network(s) 124 and/or 122). The processor 910 is configured to execute computer program instructions among the program code 922 in the memory 920, described below as a non-transitory computer readable medium, to perform some or all of the operations and methods for one or more of the embodiments disclosed herein.

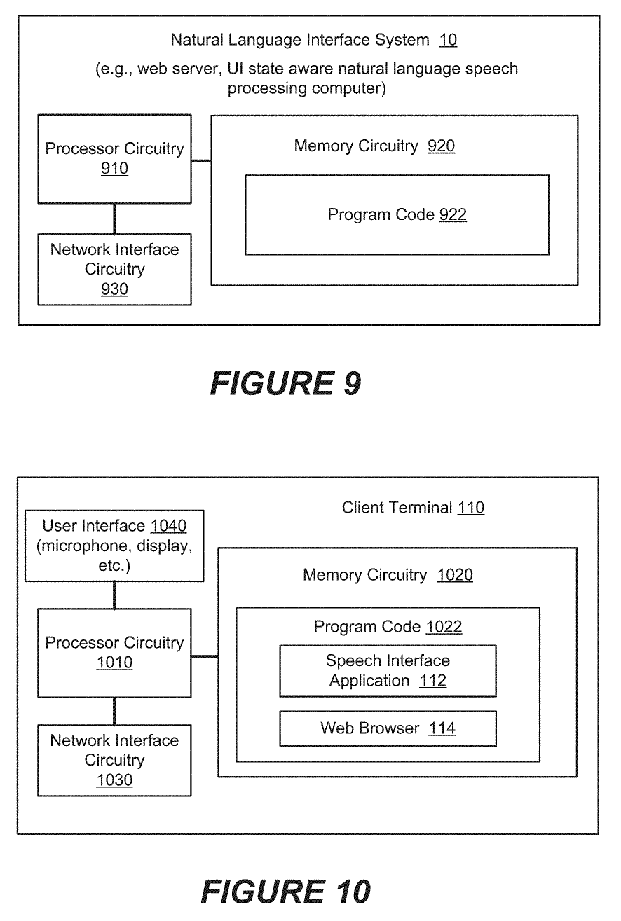

FIG. 10 is a block diagram of a client terminal 110, e.g., a wired user terminal or a wireless user terminal, that can be configured to perform operations in accordance with some embodiments. Referring to FIG. 10, the client terminal 110 can include a network interface circuitry 1030 (hereinafter “network interface”) that communicates through a wired (e.g., ethernet) and/or wireless network (e.g., IEEE 802.11, Bluetooth, and/or one or more 3GPP cellular communication protocols such as 4G, 5G, etc via the radio access network 120) and the data network 122 with the UI state aware NL speech processing computer 100. A user interface 1040 includes a microphone that senses a user's voice and a display that can display webpage generated by the web browser 114 and/or another application user interface.

The client terminal 110 includes processor circuitry 1010 (hereinafter “processor”) and memory circuitry 1020 (hereinafter “memory”) that contains computer program code 1022 which performs various operations disclosed herein when executed by the processor 1010. Program code 1022 can include the speech interface application 112 and the web browser 114 described herein. The processor 1010 may include one or more data processing circuits, such as a general purpose and/or special purpose processor (e.g., microprocessor and/or digital signal processor), which may be collocated or distributed across one or more data networks (e.g., network(s) 124 and/or 122). The processor 1010 is configured to execute computer program instructions among the program code 1022 in the memory 1020, described below as a non-transitory computer readable medium, to perform some or all of the operations and methods for one or more of the embodiments disclosed herein.

### Further Definitions and Embodiments

As will be appreciated by one skilled in the art, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus, and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” or “/” includes any and all combinations of one or more of the associated listed items.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method by a web server system comprising:
determining an identifier of a webpage being accessed by a user through a client terminal, wherein the webpage is among a set of possible webpages that are accessible to the user through the client terminal, wherein different identifiers are assigned to different ones of the webpages;
responsive to the identifier of the webpage, selecting a set of user interface (UI) input field constraints that define what the webpage allows to be input by a user to a set of UI fields which are provided by the webpage;
obtaining an output text string that is converted from a sampled audio steam by a speech-to-text conversion server and that is constrained to satisfy one of the UI field input constraints of the selected set; and
providing the output text string to an application programming interface of the webpage that corresponds to one of the UI fields having user input constrained by the one of the UI field input constraints of the selected set.

2. The method of claim 1, further comprising:
embedding the sampled audio stream in a data packet; and
communicating the data packet toward a speech-to-text conversion server via a data network,
wherein obtaining the output text string comprises:
receiving, via the data network, a data packet containing a converted text string that is converted from the sampled audio steam by the speech-to-text conversion server; and
selecting the output text string from among a defined set of candidate text strings that satisfy the one of the UI field input constraints of the selected set, based on comparison of the converted text string to the defined set of candidate text strings.

3. The method of claim 2, wherein selecting the output text string from among a defined set of candidate text strings that satisfy the one of the UI field input constraints of the selected set, based on comparison of the converted text string to the defined set of candidate text strings, comprises:
for each of the candidate text strings among the defined set, generating a confidence level score based on a level of matching between the converted text string and the candidate text string; and
selecting as the output text string one of the candidate text strings among the defined set that is used in the generation of a confidence level score that satisfies a defined selection rule.

4. The method of claim 3, wherein selecting as the output text string one of the candidate text strings among the defined set that is used in the generation of the confidence level score that satisfies the defined selection rule, comprises:
selecting as the output text string one of the candidate text strings among the defined set that is used in the generation of a greater confidence level score than the other candidate text strings among the defined set.

5. The method of claim 3,
wherein a sub-set of the UI fields among the set provided by the webpage are each associated with a respective set of candidate text strings that satisfy UI field input constraints of the respective UI field, and
further comprising identifying one of the UI fields among the sub-set of UI fields that the user has targeted for spoken input based on comparison of the converted text string to the candidate text strings in the sets,
wherein the output text string is provided to the application programming interface of the webpage that corresponds to the identified one of the UI fields.

6. The method of claim 5, wherein identifying one of the UI fields among the sub-set of UI fields that the user has targeted for spoken input based on comparison of the converted text string to the candidate text strings in the sets, comprises:
identifying one of the candidate text strings that is used to generate a confidence level score that satisfies the defined selection rule;
identifying one of the sets of candidate text strings that contains the identified one of the candidate text strings; and
identifying one of the UI fields from among the sub-set of UI fields that is associated with the identified one of the sets of candidate text strings.

7. The method of claim 3,
wherein confidence threshold values are assigned to the UI fields that are provided by the webpage, and at least some of the UI fields are assigned different confidence threshold values, and
further comprising:
identifying one of the UI fields among the set of UI fields that the user has targeted for spoken input; and
selecting one of the confidence threshold values based on the identified one of the UI fields,
wherein the defined selection rule is satisfied when the confidence level score, which is generated using one of candidate text strings, satisfies the selected one of the confidence threshold values.

8. The method of claim 7, wherein identifying one of the UI fields among the set of UI fields that the user has targeted for spoken input, comprises:
tracking historical ordered sequences for which user input has been provided to the UI fields among the set of UI fields of the webpage over time;
identifying a present sequence of at least two of the UI fields among the set of UI fields of the webpage that the user has immediately previously targeted for spoken inputs;
predicting a next one of the UI fields among the set of UI fields of the webpage that the user will target for spoken input, based on comparison of the present sequence to the historical ordered sequences, wherein the predicted next one of the UI fields is the identified one of the UI fields.

9. The method of claim 3,
wherein confidence threshold values are assigned to the UI fields that are provided by the webpage, and at least some of the UI fields are assigned different confidence threshold values, and
further comprising:
identifying one of the UI fields among the set of UI fields that the user has targeted for spoken input;
selecting one of the confidence threshold values based on the identified one of the UI fields;
comparing the confidence level score, which is generated using one of candidate text strings, to the selected one of the confidence threshold values;
responsive to the confidence level score satisfying the selected one of the confidence threshold values, performing the providing of the output text string to the application programming interface of the webpage that corresponds to the identified one of the UI fields; and
responsive to the confidence level score not satisfying the selected one of the confidence threshold values, preventing the output text string from being provided to the application programming interface of the webpage that corresponds to the identified one of the UI fields.

10. A method by a natural language speech processing computer comprising:
determining an identifier of a presently active user interface (UI) operational state of an application executed by a computer terminal, wherein the presently active UI operational state is among a set of possible UI operational states of the application, wherein different identifiers are assigned to different ones of the possible UI operational states;
responsive to the identifier of the presently active UI operational state, selecting a set of UI field input constraints that define what the application allows to be input by a user to a set of UI fields which are provided by the presently active UI operational state of the application;
obtaining an output text string that is converted from a sampled audio steam by a speech-to-text conversion server and that is constrained to satisfy one of the UI field input constraints of the selected set; and
providing the output text string to an application programming interface of the application that corresponds to one of the UI fields having user input constrained by the one of the UI field input constraints of the selected set.

11. The method of claim 10, further comprising:
embedding the sampled audio stream in a data packet; and
communicating the data packet toward a speech-to-text conversion server via a data network,
wherein obtaining the output text string comprises:
receiving, via the data network, a data packet containing a converted text string that is converted from the sampled audio steam by the speech-to-text conversion server; and
selecting the output text string from among a defined set of candidate text strings that satisfy the one of the UI field input constraints of the selected set, based on comparison of the converted text string to the defined set of candidate text strings.

12. The method of claim 11, wherein selecting the output text string from among a defined set of candidate text strings that satisfy the one of the UI field input constraints of the selected set, based on comparison of the converted text string to the defined set of candidate text strings, comprises:
for each of the candidate text strings among the defined set, generating a confidence level score based on a level of matching between the converted text string and the candidate text string; and
selecting as the output text string one of the candidate text strings among the defined set that is used in the generation of a confidence level score that satisfies a defined selection rule.

13. The method of claim 12, wherein selecting as the output text string one of the candidate text strings among the defined set that is used in the generation of the confidence level score that satisfies the defined selection rule, comprises:
selecting as the output text string one of the candidate text strings among the defined set that is used in the generation of a greater confidence level score than the other candidate text strings among the defined set.

14. The method of claim 12,
wherein a sub-set of the UI fields among the set provided by the presently active UI operational state of the application are each associated with a respective set of candidate text strings that satisfy UI field input constraints of the respective UI field, and
further comprising identifying one of the UI fields among the sub-set of UI fields that the user has targeted for spoken input based on comparison of the converted text string to the candidate text strings in the sets,
wherein the output text string is provided to the application programming interface of the application that corresponds to the identified one of the UI fields.

15. The method of claim 14, wherein identifying one of the UI fields among the sub-set of UI fields that the user has targeted for spoken input based on comparison of the converted text string to the candidate text strings in the sets, comprises:
identifying one of the candidate text strings that is used to generate a confidence level score that satisfies the defined selection rule;
identifying one of the sets of candidate text strings that contains the identified one of the candidate text strings; and
identifying one of the UI fields from among the sub-set of UI fields that is associated with the identified one of the sets of candidate text strings.

16. The method of claim 12,
wherein confidence threshold values are assigned to the UI fields that are provided by the presently active UI operational state of the application, and at least some of the UI fields are assigned different confidence threshold values, and
further comprising:
identifying one of the UI fields among the set of UI fields that the user has targeted for spoken input; and
selecting one of the confidence threshold values based on the identified one of the UI fields,
wherein the defined selection rule is satisfied when the confidence level score, which is generated using one of candidate text strings, satisfies the selected one of the confidence threshold values.

17. The method of claim 16, wherein identifying one of the UI fields among the set of UI fields that the user has targeted for spoken input, comprises:
tracking historical ordered sequences for which user input has been provided to the UI fields among the set of UI fields over time;
identifying a present sequence of at least two of the UI fields among the set of UI fields that the user has immediately previously targeted for spoken inputs;
predicting a next one of the UI fields among the set of UI fields that the user will target for spoken input, based on comparison of the present sequence to the historical ordered sequences, wherein the predicted next one of the UI fields is the identified one of the UI fields.

18. The method of claim 12,
wherein confidence threshold values are assigned to the UI fields that are provided by the presently active UI operational state of the application, and at least some of the UI fields are assigned different confidence threshold values, and
further comprising:
identifying one of the UI fields among the set of UI fields that the user has targeted for spoken input;
selecting one of the confidence threshold values based on the identified one of the UI fields;
comparing the confidence level score, which is generated using one of candidate text strings, to the selected one of the confidence threshold values;
responsive to the confidence level score satisfying the selected one of the confidence threshold values, performing the providing of the output text string to the application programming interface of the application that corresponds to the identified one of the UI fields; and
responsive to the confidence level score not satisfying the selected one of the confidence threshold values, preventing the output text string from being provided to the application programming interface of the application that corresponds to the identified one of the UI fields.

19. A web server system comprising:
a network interface configured to communicate with a speech-to-text conversion server;
a processor connected to receive the data packets from the network interface; and
a memory storing program instructions executable by the processor to perform operations comprising:
determining an identifier of a webpage being accessed by a user through a client terminal, wherein the webpage is among a set of possible webpages that are accessible to the user through the client terminal, wherein different identifiers are assigned to different ones of the webpages;
responsive to the identifier of the webpage, selecting a set of user interface (UI) input field constraints that define what the webpage allows to be input by a user to a set of UI fields which are provided by the webpage;
obtaining an output text string that is converted from a sampled audio steam by a speech-to-text conversion server and that is constrained to satisfy one of the UI field input constraints of the selected set; and
providing the output text string to an application programming interface of the webpage that corresponds to one of the UI fields having user input constrained by the one of the UI field input constraints of the selected set.

20. The web server system of claim 19, further comprising:
embedding the sampled audio stream in a data packet; and
communicating the data packet toward a speech-to-text conversion server via a data network,
wherein obtaining the output text string comprises:
receiving, via the data network, a data packet containing a converted text string that is converted from the sampled audio steam by the speech-to-text conversion server;
for each of the candidate text strings among the defined set, generating a confidence level score based on a level of matching between the converted text string and the candidate text string; and
selecting as the output text string one of the candidate text strings among the defined set that is used in the generation of a confidence level score that satisfies a defined selection rule.
